(19) United States
(12) Patent Application Publication
(10) Pub. No.: US 2025/0346034 A1
(43) Pub. Date: Nov. 13, 2025

(54) MAINTENANCE DEVICE AND INKJET RECORDING APPARATUS

(71) Applicant: KYOCERA Document Solutions Inc., Osaka (JP)

(72) Inventors: Shuhei KAWAMATA, Osaka (JP); Shunsuke YAMASAKI, Osaka (JP); Yasutaka INUI, Osaka (JP); Yuko YANO, Osaka (JP)

(73) Assignee: KYOCERA Document Solutions Inc., Osaka (JP)

(21) Appl. No.: 19/199,265

(22) Filed: May 5, 2025

(30) Foreign Application Priority Data
May 8, 2024 (JP) 2024-075672

(51) Int. Cl. B41J 2/165; B41J 2/17

(52) U.S. Cl. CPC B41J 2/16538; B41J 2/1742; B41P 2235/21

(57) ABSTRACT

A maintenance device includes a blade unit, a support, and a blade sliding device. The blade unit includes a blade in contact with a nozzle surface of an inkjet head. To the support, the blade unit is detachably attached. The blade sliding device slides the support to a predetermined moving direction along the nozzle surface. The blade unit has a through-hole penetrating in an upper-and-lower direction. The support has a projection portion which is engaged with the through-hole. The projection portion protrudes upward and is inclined with respect to a vertical direction.

### INCORPORATION BY REFERENCE

This application is based on and claims the benefit of priority from Japanese patent application No. 2024-075672 filed on May 8, 2024 which is incorporated by reference in its entirety.

### BACKGROUND

The present disclosure relates to a maintenance device and an inkjet recording apparatus.

In the inkjet recording apparatus, it is considered that moisture evaporates from ink in a nozzle of an inkjet head during a period when an image forming job is not performed, and the nozzle is clogged due to an increase in a viscosity of the ink. To prevent the clogging, a purge treatment in which the ink in the nozzle is purged to a cap is performed. However, if the ink remaining on the nozzle surface is left, there is a problem that the ink falls on a sheet during the image forming job or the ink sticks to the nozzle surface. Therefore, a technique for removing the ink remaining on the nozzle surface has been studied. For example, a configuration has been proposed in which a blade in contact with the nozzle surface is slid to remove the ink from the nozzle surface.

In a configuration in which the nozzle surface is cleaned by the blade, the nozzle surface is cleaned by driving a support supporting a blade unit having the blade in a predetermined direction. However, the blade may be worn or deformed during repeated cleaning by the blade. In addition, the components of the waste liquid may adhere to the blade unit, causing trouble in the operation of the blade. For these reasons, it is necessary to periodically replace the blade and to clean the blade unit, and at this time, it is necessary to attach and detach the blade unit to and from the support. In order to facilitate the attachment and detachment, for example, a configuration in which the blade unit is engaged with a projection provided on the support may be considered, but while the attachment and detachment are easy, there is a problem that the blade unit tends to fall off or float.

### SUMMARY

A maintenance device according to the present disclosure includes a blade unit, a support, and a blade sliding device. The blade unit includes a blade in contact with a nozzle surface of an inkjet head. To the support, the blade unit is detachably attached. The blade sliding device slides the support to a predetermined moving direction along the nozzle surface. The blade unit has a through-hole penetrating in an upper-and-lower direction. The support has a projection portion which is engaged with the through-hole. The projection portion protrudes upward and is inclined with respect to a vertical direction.

An inkjet recording apparatus according to the present disclosure includes the maintenance device and the inkjet head.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an appearance of an image forming system according to one embodiment of the present disclosure.

FIG. 2 is a front view schematically showing an internal structure of the inkjet recording apparatus according to the embodiment of the present disclosure.

FIG. 3 is a front view schematically showing a head unit and a maintenance device according to the embodiment of the present disclosure.

FIG. 4 is a plan view schematically showing the head unit and a wipe unit according to the embodiment of the present disclosure.

FIG. 5 is a plan view schematically showing a cap unit according to the embodiment of the present disclosure.

FIG. 6 is a cross-sectional view showing an inkjet head according to the embodiment of the present disclosure.

FIG. 7 is a perspective view showing the wipe unit and a cleaning liquid supply source according to the embodiment of the present disclosure.

FIG. 8 is a perspective view showing the wipe unit according to the embodiment of the present disclosure.

FIG. 9 is a perspective view showing a blade unit according to the embodiment of the present disclosure.

FIG. 10 is a perspective view showing a cross section of the blade unit according to the embodiment of the present disclosure.

FIG. 11 is a perspective view showing a protruding member and a blade according to the embodiment of the present disclosure.

FIG. 12 is a perspective view showing the protruding member according to the embodiment of the present disclosure.

FIG. 13 is a perspective view showing a receiving member according to the embodiment of the present disclosure.

FIG. 14 is a perspective view showing the receiving member according to an embodiment of the present disclosure.

FIG. 15 is a perspective view showing a cleaning liquid supply part and the blade unit according to the embodiment of the present disclosure.

FIG. 16 is a left side view showing the cleaning liquid supply part and the blade unit according to the embodiment of the present disclosure.

FIG. 17 is a left side view showing the cleaning liquid supply part and the blade unit according to the embodiment of the present disclosure.

FIG. 18 is a perspective view showing the cleaning liquid supply part according to the embodiment of the present disclosure.

FIG. 19 is a perspective view showing a cross section of the cleaning liquid supply part and the cleaning liquid supply source according to the embodiment of the present disclosure.

FIG. 20 is a perspective view showing a cross section of the cleaning liquid supply part and the cleaning liquid supply source according to the embodiment of the present disclosure.

FIG. 21 is a perspective view showing a cross section of the cleaning liquid supply part and the cleaning liquid supply source according to the embodiment of the present disclosure.

FIG. 22 is a perspective view showing a cross section of the cleaning liquid supply part and the cleaning liquid supply source according to the embodiment of the present disclosure.

FIG. 23 is a perspective view showing a blade sliding device according to the embodiment of the present disclosure.

FIG. 24 is a left side view showing a support according to the embodiment of the present disclosure.

FIG. 25 is a perspective view showing an engagement member according to the embodiment of the present disclosure.

FIG. 26 is a cross-sectional view showing a change in posture of the engagement member when attached and detached to and from a projection portion according to the embodiment of the present invention.

FIG. 27 is a perspective view showing a restriction member according to the embodiment of the present disclosure.

FIG. 28 is a perspective view showing a state in which the restriction member is attached to the projection portion according to the embodiment of the present disclosure.

FIG. 29A-29G are front view showing an operation of the maintenance device according to the embodiment of the present disclosure.

FIG. 30A-30D are plan view showing the operation of the maintenance device according to the embodiment of the present disclosure.

FIG. 31 is a left side view showing an operation of the wipe unit according to the embodiment of the present disclosure.

FIG. 32 is a left side view showing the operation of the wipe unit according to the embodiment of the present disclosure.

FIG. 33 is a left side view showing the operation of the wipe unit according to the embodiment of the present disclosure.

FIG. 34 is a left side view showing the operation of the wipe unit according to the embodiment of the present disclosure.

FIG. 35 is a left side view showing the operation of the wipe unit according to the embodiment of the present disclosure.

FIG. 36 is a left side view showing the operation of the wipe unit according to the embodiment of the present disclosure.

### DETAILED DESCRIPTION

Hereinafter, with reference to the drawings, an inkjet recording apparatus 1 according to one embodiment of the present disclosure will be described.

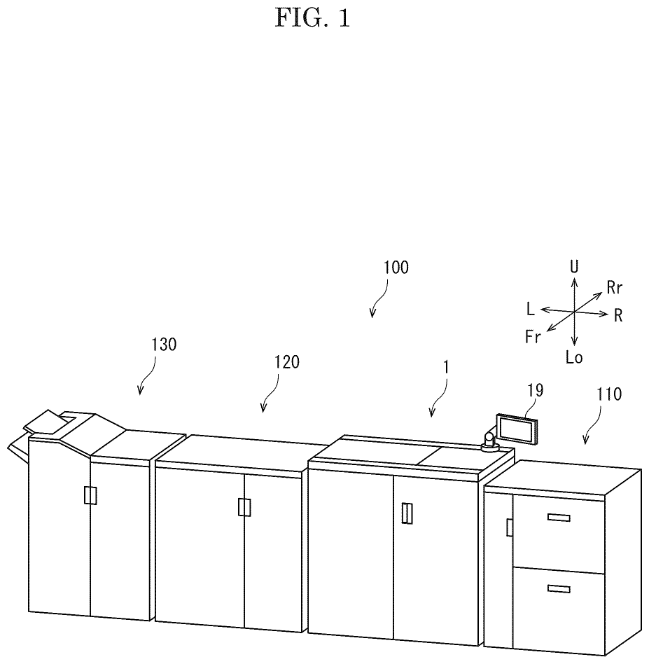

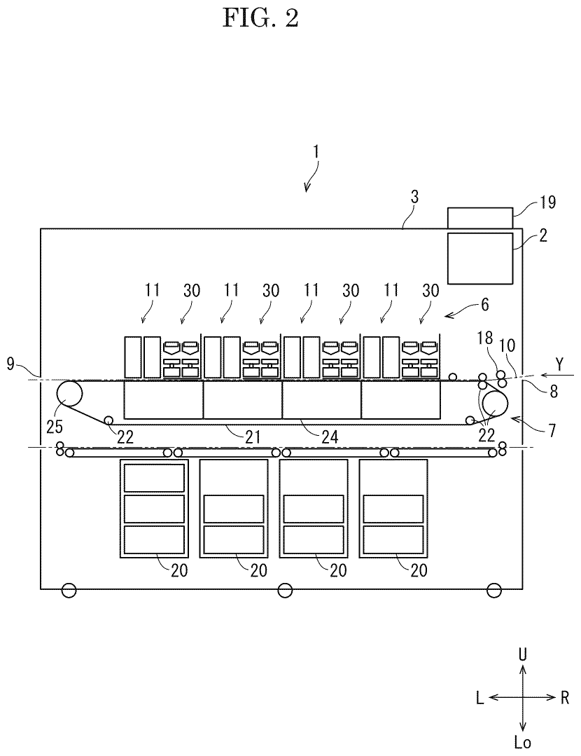

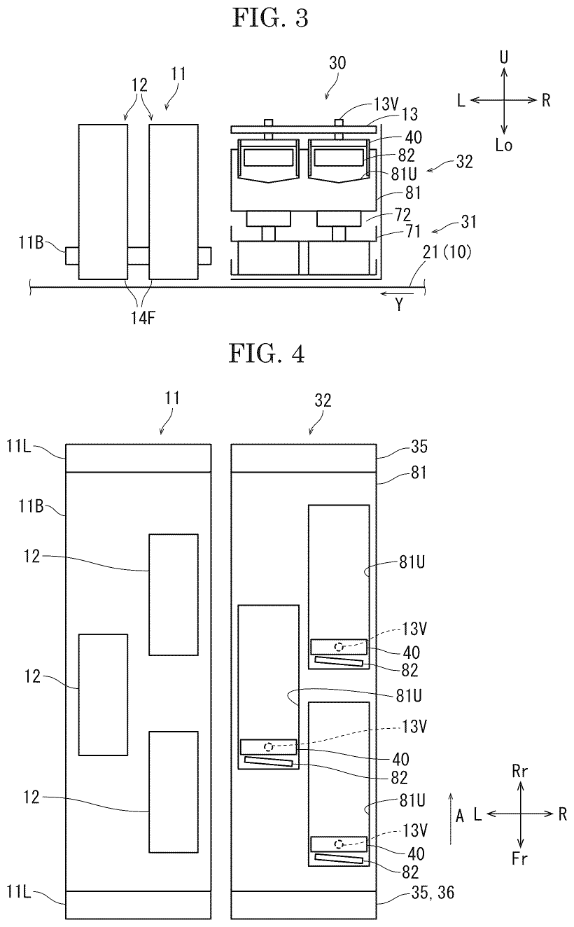

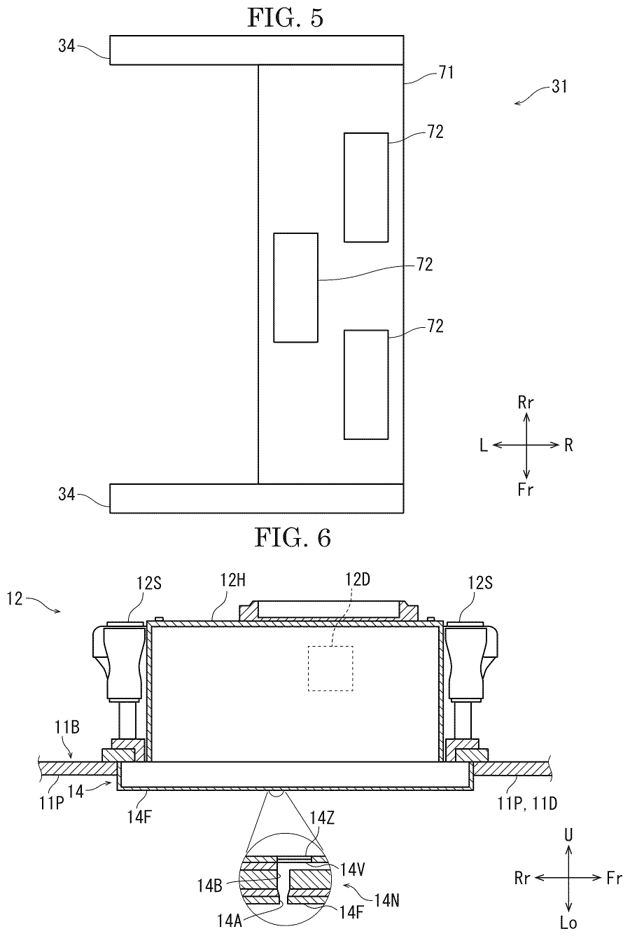

FIG. 1 is a perspective view showing an appearance of the image forming system 100. FIG. 2 is a front view schematically showing an internal structure of the inkjet recording apparatus 1. FIG. 3 is a front view schematically showing a head unit 11 and a maintenance device 30. FIG. 4 is a plan view schematically showing the head unit 11 and a wipe unit 32. FIG. 5 is a plan view schematically showing a cap unit 31. FIG. 6 is a cross-sectional view showing an inkjet head 12. Hereinafter, the front side of the paper plane on which FIG. 2 is drawn is set to the front side of the inkjet recording apparatus 1, and the left-and-right direction is described with reference to the direction when the inkjet recording apparatus 1 is viewed from the front side. In each figure, U, Lo, L, R, Fr, and Rr indicate the upper, lower, left, right, front, and rear, respectively.

The image forming system 100 (see FIG. 1) includes a sheet feeding apparatus 110, an inkjet recording apparatus 1, a drying apparatus 120, and a post-processing apparatus 130. The sheet feeding apparatus 110 stores several thousand of sheets S, and feeds the sheet S to the inkjet recording apparatus 1. The inkjet recording apparatus 1 forms an image on the sheet S by an inkjet method. The drying apparatus 120 heats the sheet conveyed from the inkjet recording apparatus 1, and dries ink. The post-processing apparatus 130 performs post-processing such as drilling, stapling, and folding on the sheet S.

The inkjet recording apparatus 1 (see FIG. 2) includes a parallelepiped body housing 3. In the center portion of the inside of the body housing 3, a conveying unit 7 which attracts the sheet S and conveys it in the Y direction is provided. Above the conveying unit 7, an image forming unit 6 which forms an image by ejecting the ink is provided. On the right surface of the body housing 3, a sheet feeding port 8 through which the sheet S is received from the sheet feeding apparatus 110 is provided. On the left side surface of the body housing 3, a discharge port 9 through which the sheet S on which the image is formed is discharged to the drying apparatus 120 is provided. Inside the body housing 3, a conveyance path 10 is provided from the sheet feeding port 8 to the discharge port 9 through a gap between the conveying unit 7 and the image forming unit 6. A registration roller 18 is provided on the upstream side of the conveying unit 7 in the conveyance direction Y.

The conveying unit 7 includes an endless conveying belt 21 and a suction part 24. The conveying belt 21 has a large number of air holes (not shown), and is wound around a driving roller 25 and a driven roller 22. The upper surface of the suction part 24 has a large number of air holes (not shown), and is in contact with the inner surface of the conveying belt 21. The suction part 24 sucks air through the air holes of the conveying belt 21 and the air holes of the suction part 24, so that the sheet S is attracted to the conveying belt 21. When the driving roller 25 is driven in the counterclockwise direction by a driving part (not shown) including a motor and a reduction gear, the conveying belt 21 travels in the counterclockwise direction, and the sheet S attracted to the conveying belt 21 is conveyed.

The image forming unit 6 includes a plurality (in this embodiment, four) of head units 11. The head unit 11 (see FIG. 3, FIG. 4) includes one or more inkjet heads 12 (in the present embodiment, three). Ink containers 20 filled with the black, cyan, magenta, and yellow ink are connected to the respective head units 11.

The inkjet head 12 (see FIG. 6) includes a rectangular parallelepiped housing 12H whose longitudinal direction is along the front-and-rear direction, a nozzle plate 14 provided at the bottom of the housing 12H, and a socket 12S to which a pipe for supplying the ink is connected. The nozzle plate 14 is provided with a large number of nozzles 14N arranged in the front-and-rear direction. The nozzle 14N includes a branch channel 14B branched from the downstream side of the socket 12S, and an ejection port 14A provided on a nozzle surface 14F which is the lower surface of the nozzle plate 14. A diaphragm 14V also serves as a part of the inner wall of the branch channel 14B. The diaphragm 14V is provided with a pressurizing element 14Z. As the pressurizing element 14Z, a piezoelectric element, an electrostatic actuator, a heater or the like are used. A driving circuit 12D for driving the pressurizing element 14Z is connected to the pressurizing element 14Z.

[Head Base] The head unit 11 includes a head base 11B (see FIG. 3, FIG. 4 and FIG. 6) which supports the inkjet heads 12. On the head base 11B, the three inkjet heads 12 are provided in a staggered pattern. The head base 11B is a generally rectangular plate-like member. The head base 11B has through-holes (not shown) into which the nozzle plates 14 of the inkjet heads 12 are inserted. The lower surface of the head base 11B is a surface parallel to the nozzle surface 14F (hereinafter, it is referred to as a parallel surface 11P). The nozzle surface 14F protrudes downward from the parallel surface 11P.

A control part 2 (see FIG. 2) includes an arithmetic part and a storage part (not shown). The arithmetic part is, for example, a CPU (Central Processing Unit). The storage part includes a storage medium such as ROM (Read Only Memory), RAM (Random Access Memory), EEPROM (Electrically Erasable Programmable Read Only Memory), and the like. The arithmetic part reads the control program stored in the storage part and executes various processes. The control part 2 may be implemented by an integrated circuit that does not use software.

A display operation part 19 is provided on the upper portion of the body housing 3 (see FIG. 1, FIG. 2). The display operation part 19 includes a display panel, a touch panel laminated on the display panel, and a keypad (not shown). The control part 2 displays a screen representing an operation menu, a status, or the like of the inkjet recording apparatus 1 on the display panel, and controls each part of the inkjet recording apparatus 1 in accordance with the operation detected by the touch panel and the keypad.

The basic image forming operation of the inkjet recording apparatus 1 is as follows. When an image forming job is inputted to the inkjet recording apparatus 1 from the display operation part 19 or an external computer, the sheet feeding apparatus 110 feeds the sheet S to the conveyance path 10 through the sheet feeding port 8, and the registration roller 18 whose rotation is stopped corrects the skew of the sheet S. When the registration roller 18 sends the sheet S to the conveying unit 7 at a predetermined timing, the conveying unit 7 attracts the sheet S to the conveying belt 21, and conveys the sheet S in the Y direction. The ink is ejected from the nozzle to form an image on the sheet S. The sheet S on which the image is formed is conveyed to the drying apparatus 120 through the discharge port 9.

[Maintenance Device] Next, a maintenance device 30 will be described. Since the four head units 11 (see FIG. 2) have the same configuration and the four maintenance devices 30 have the same configuration, one head unit 11 and one maintenance device 30 for performing maintenance of the head unit 11 will be described below.

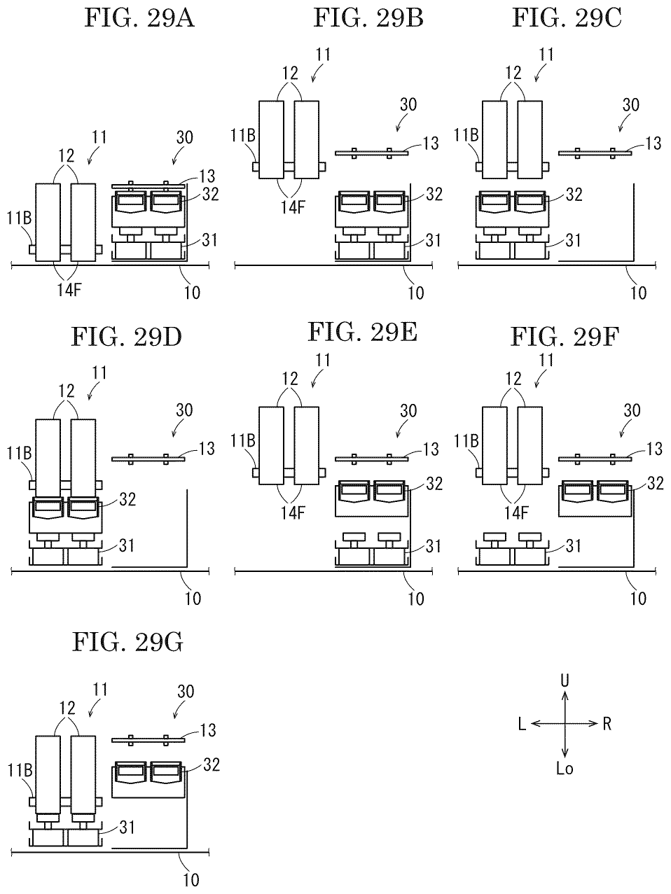

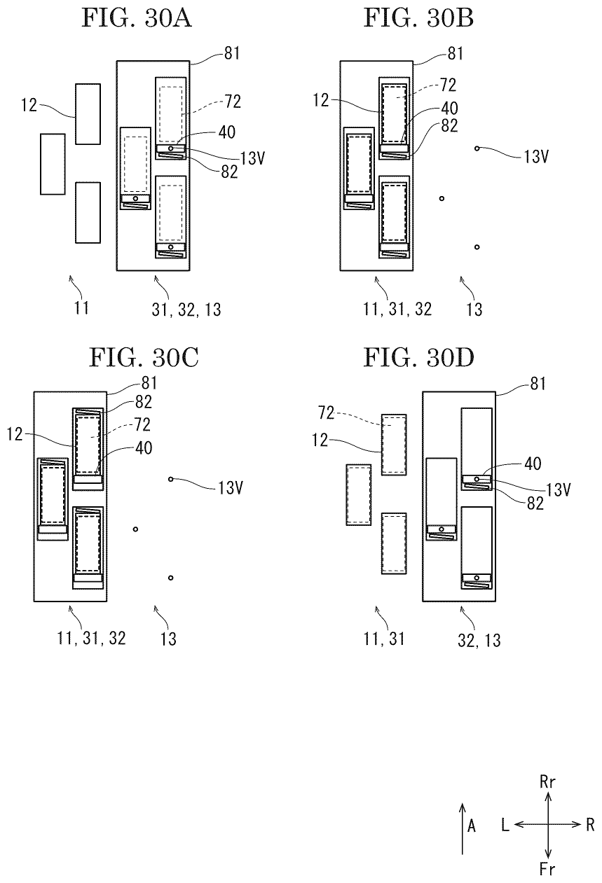

The maintenance device 30 (see FIG. 3) is provided on the lateral side (in this embodiment, the upstream side in the conveyance direction Y (the right side)) of the head unit 11. The maintenance device 30 includes a cap unit 31, a wipe unit 32, and a cleaning liquid supply source 13.

[Cap Unit] The cap unit 31 (see FIG. 3 and FIG. 5) is provided with the same number (in this embodiment, three) of caps 72 as the inkjet heads 12 provided in the head unit 11. The three caps 72 are arranged in a staggered pattern in the same manner as the inkjet heads 12, and are supported by a frame 71.

[Wipe Unit] The wipe unit 32 (see FIG. 3 and FIG. 4) includes a waste liquid tray 81, a blade 82, and a cleaning liquid supply part 40. The waste liquid tray 81 is provided with the same number of recesses 81U as the inkjet heads 12 provided in the head unit 11. The recesses 81U are arranged in a staggered pattern in the same manner as the inkjet heads 12. The blade 82 and the cleaning liquid supply part 40 are provided in each of the recesses 81U.

[Head Lifting Device] FIG. 29 is a front view showing an operation of the maintenance device 30. Head lifting devices 11L (see FIG. 4) are provided on the front and rear sides of the head base 11B, respectively. The head lifting device 11L is constituted of, for example, a ball screw, a belt driving device, and the like. The head lifting devices 11L lift and lower the head unit 11 between an image forming position (see FIG. 29A) and a retracted position (see FIG. 29B). The image forming position is a position where a distance between the conveyance path 10 (the upper surface of the conveying belt 21) along which the sheet is conveyed and the nozzle surface 14F is a predetermined distance suitable for the image formation. The retracted position is a position higher than the image forming position, and is a position where the head unit 11 does not interfere with the wipe unit 32 when the cap unit 31 and the wipe unit 32 are horizontally slid using a cap sliding device 34 described later.

[Cap Sliding Device] FIG. 30 is a plan view showing an operation of the maintenance device 30. The cap sliding devices 34 (see FIG. 5) are provided on the front and rear sides of the frame 71 of the cap unit 31, respectively. The cap sliding device 34 is constituted of, for example, a ball screw, a belt driving device, and the like. The cap sliding devices 34 slide the cap unit 31 to a home position (see FIG. 29A and FIG. 30A) and a maintenance position (see FIG. 29F and FIG. 30D). The home position is a position on the right side of the head unit 11 positioned at the image forming position. The maintenance position is a position below the head unit 11 positioned at the retracted position.

[Wipe Lifting Device] Wipe lifting devices 35 (see FIG. 4) are provided on the front and rear sides of the waste liquid tray 81 of the wipe unit 32, respectively. The wipe lifting device 35 is constituted of, for example, a cam mechanism, a ball screw, or the like. The wipe lifting devices 35 lift and lower the wipe unit 32 to a contact position (see FIG. 29B) and a separated position (see FIG. 29E). The contact position is a position where the waste liquid tray 81 is in contact with the caps 72. The separated position is a position where the waste liquid tray 81 is separated upward by a predetermined distance from the caps 72.

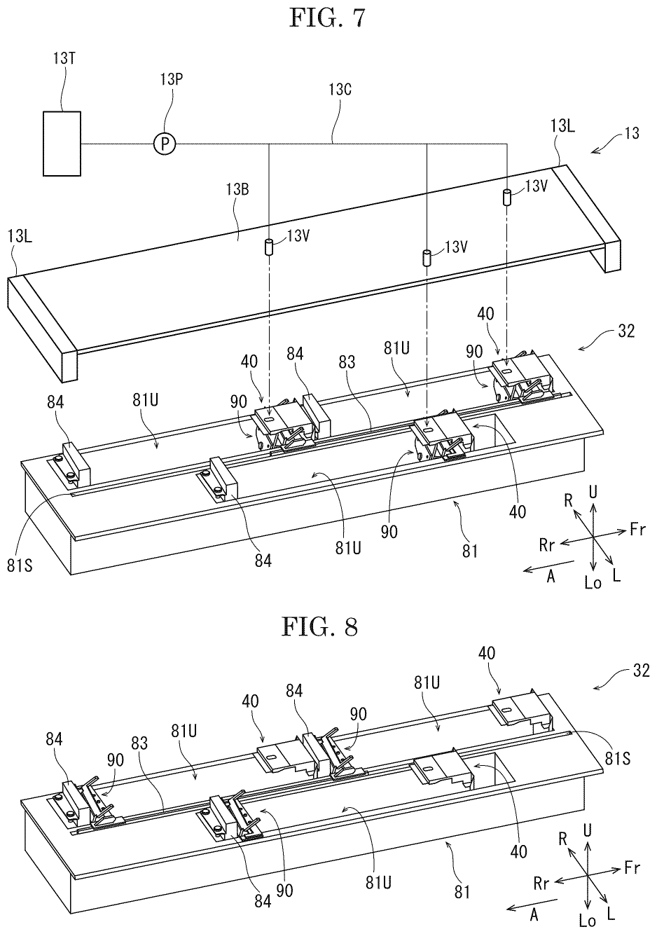

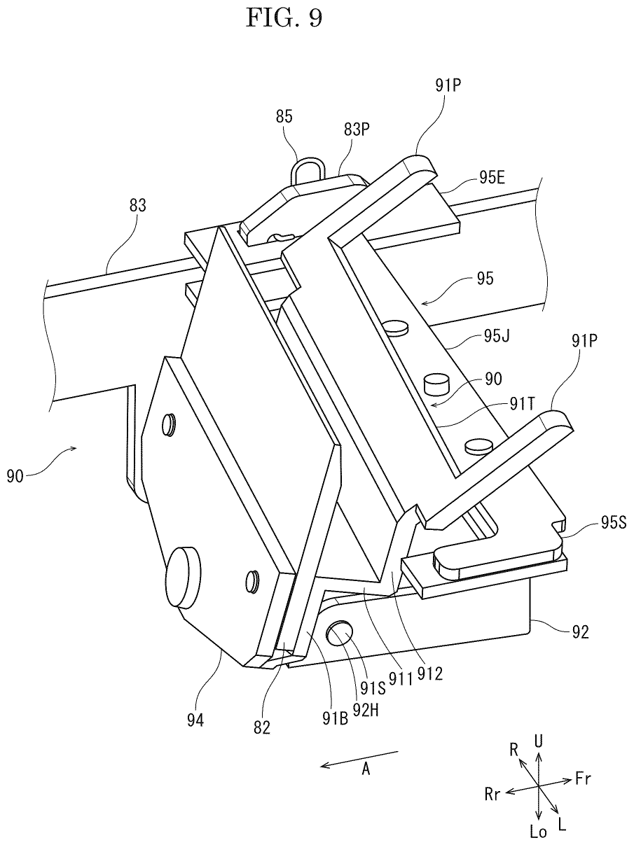

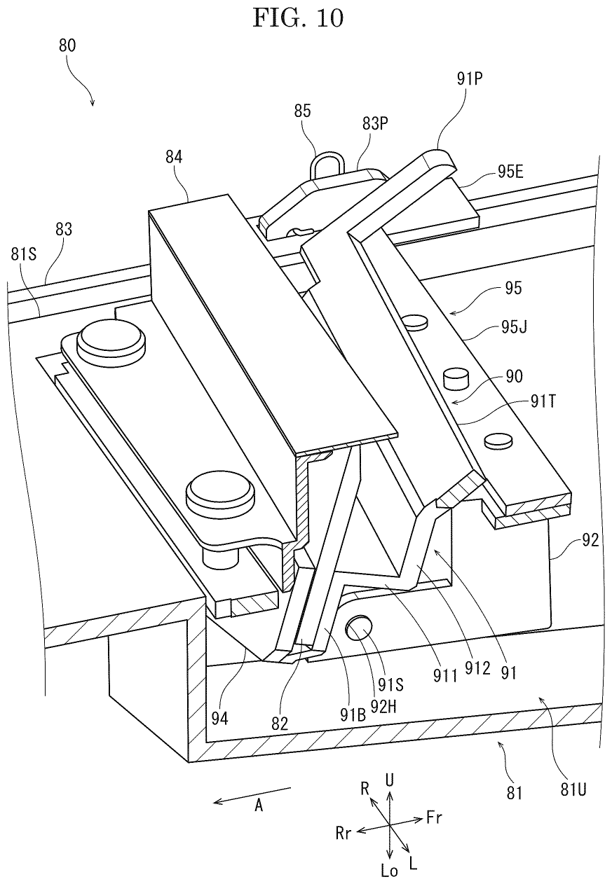

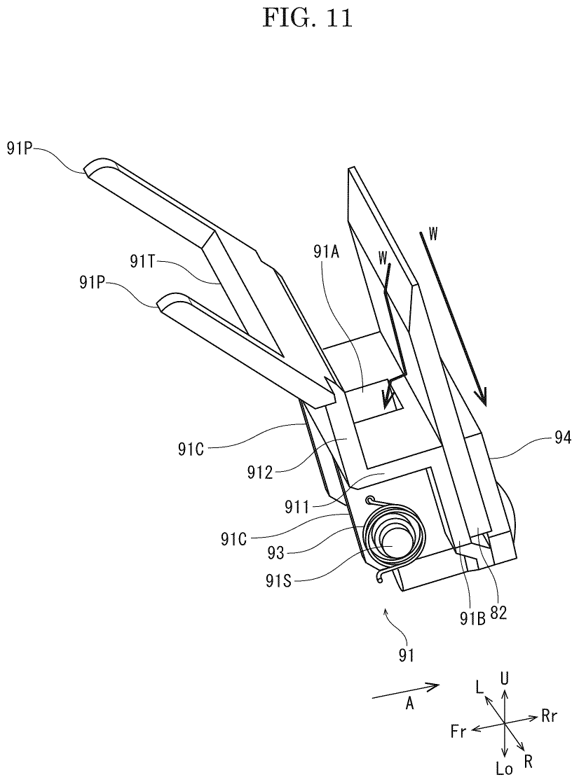

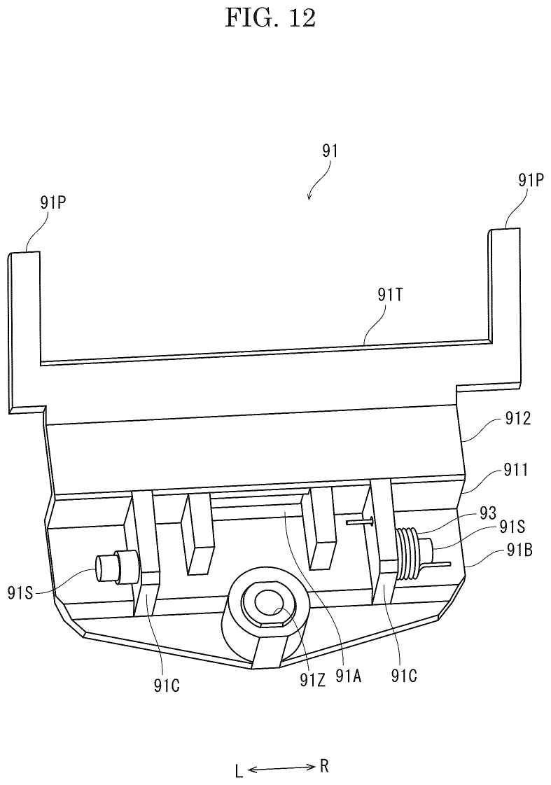

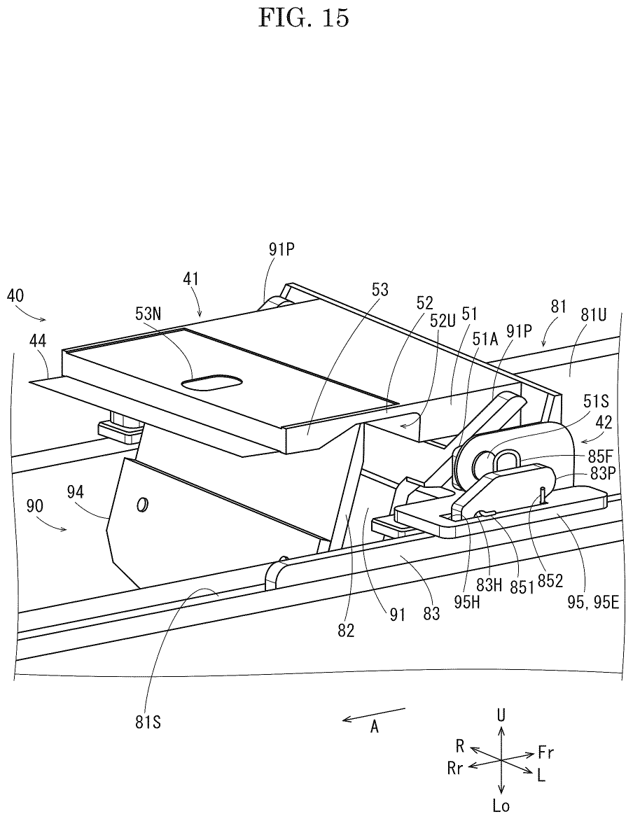

When the wipe unit 32 is positioned at the contact position, since the wipe unit 32 is placed on the cap unit 31, when the cap sliding devices 34 are operated, the wipe unit 32 is slid to the home position (see FIG. 29A and FIG. 30A) and the maintenance position (see FIG. 29C and FIG. 30B) together with the cap unit 31. That is, the cap sliding device 34 has also a function of sliding the wipe unit 32 to the home position and the maintenance position. When the wipe unit 32 is positioned at the separated position, when the cap sliding devices 34 are operated, the cap unit 31 is slid independently to the home position (see FIG. 29E and FIG. 30A) and the maintenance position (see FIG. 29F and FIG. 30D) while leaving the wipe unit 32 at the home position.

[Wipe Unit] Next, the structure of the wipe unit 32 will be described in detail. FIG. 7 is a perspective view showing the wipe unit 32 and the cleaning liquid supply source 13. FIG. 8 is a perspective view showing the wipe unit 32. FIG. 9 is a perspective view showing a blade unit 90. FIG. 10 is a perspective view showing a cross section of the blade unit 90. FIG. 11 is a perspective view showing a protruding member 91 and a blade 82. FIG. 12 is a perspective view showing the protruding member 91. FIG. 15 is a perspective view showing a cleaning liquid supply part 40 and the blade unit 90. FIG. 9 and FIG. 10 show the blade unit 90 provided in the left recess 81U of the waste liquid tray 81, and FIG. 15 shows the blade unit 90 provided in the right recess 81U of the waste liquid tray 81.

The wipe unit 32 (see FIG. 7) includes the waste liquid tray 81, a plurality of (in this embodiment, three) blade units 90, and a support 83. In FIG. 7 and the others, a moving direction A is shown. The blade unit 90 performs a wiping operation (an operation in which the waste liquid W is removed from the nozzle surface 14F using the blade 82) along the shown moving direction A. The moving direction A is a direction from the front side to the rear side of the inkjet recording apparatus 1.

[Waste Liquid Tray] The waste liquid tray 81 (see FIG. 7 and FIG. 8) is formed in a parallelepiped shape whose longitudinal direction is along the front-and-rear direction as a whole. The waste liquid tray 81 has three recesses 81U with the upper side open. The three recesses 81U are arranged in a staggered pattern in the same manner as the inkjet heads 12. The recess 81U is formed in a rectangular shape elongated in the front-and-rear direction when viewed from the upper side. A length of the recess 81U in the front-and-rear direction is longer than that of the nozzle surface 14F, and a width of the recess 81U in the left-and-right direction is wider than that of the nozzle surface 14F. The recess 81U receives the waste liquid containing the ink and the cleaning liquid. A slit 81S along the front-and-rear direction is provided between the left one recess 81U and the right two recessed 81U. In each of the three recesses 81U, the blade unit 90 is housed.

[Blade Unit] The blade unit 90 (see FIG. 9 and FIG. 10) includes the blade 82, the protruding member 91, a holder 92, a first biasing member 93 and an engagement member 95.

[Blade] The blade 82 (see FIG. 9 to FIG. 11) is a flexible, generally rectangular plate-like member made of resin or the like. The blade 82 is held by the holder 92 in a slightly forward inclined posture (a posture inclined rearward in the moving direction A) with the thickness direction being along the front-and-rear direction. A width of the blade 82 in the left-and-right direction is equal to or larger than a width of the nozzle surface 14F. The upper portion of the blade 82 is tapered so as to be thinner toward the tip end.

[Protruding Member] The protruding member 91 (see FIG. 9 to FIG. 12) has a base portion 91B parallel to the blade 82, a first bent portion 911 bent forward from the upper end of the base portion 91B, a second bent portion 912 bent upward from the front end of the first bent portion 911, an inclined portion 91T inclined more forward than the second bent portion 912, and protruding portions 91P protruding upward from both left and right ends of the inclined portion 91T and inclined at the same inclination angle as that of the inclined portion 91T.

A width of the base portion 91B in the left-and-right direction is equal to a width of the blade 82. A length of the base portion 91B in the upper-and-lower direction is shorter than a length of the blade 82 in the upper-and-lower direction. The base portion 91B is joined on the lower portion of the rear surface of the blade 82. Widths of the first bent portion 911 and the second bent portion 912 in the left-and-right direction are equal to a width of the base portion 91B. A width of the inclined portion 91T in the left-and-right direction is wider than a width of the base portion 91B. The position of the protruding portions 91P in the left-and-right direction is determined so that the distal ends of the protruding portions 91P can be in contact with the left and right parallel surfaces 11P of the nozzle surface 14F.

On the front surface of the base portion 91B, two wall portions 91C facing each other in the left-and-right direction are provided (see FIG. 11 and FIG. 12). A shaft portion 91S protruding leftward is provided on the left surface of the left wall portion 91C. A shaft portion 91S protruding rightward is provided on the right surface of the right wall portion 91C.

A through-hole 91A penetrating in the upper-and-lower direction is provided at the center portion of the first bent portion 911 in the left-and-right direction (see FIG. 11 and FIG. 12). At least a part of the waste liquid W (a mixture of the ink and the cleaning liquid) flowing down along the front surface of the blade 82 falls downward through the through-hole 91A.

The lower portion of the blade 82 is held between the base portion 91B of the protruding member 91 and a fixing member 94 (see FIG. 9 to FIG. 11), and the fixing member 94 is fastened to the protruding member 91. The lower edge portion of the fixing member 94 and the lower edge portion of the protruding member 91 are tapered such that their widths in the left-and-right direction become narrower toward the lower ends (see FIG. 9 and FIG. 12). The waste liquid flowing downward from the rear surface of the blade 82 to the rear surface of the fixing member 94 is collected at the center in the left-and-right direction along the lower edge portion of the fixing member 94 and the lower edge portion of the protruding member 91, and falls into the recess 81U of the waste liquid tray 81.

[Holder] The holder 92 (see FIG. 9 to FIG. 11) holds the blade 82 through the protruding member 91. The lower portion of the holder 92 is provided with shaft holes 92H into which the shaft portions 91S of the protruding member 91 are inserted. The protruding member 91 can be turned in the front-and-rear direction around the shaft portions 91S. The blade 82 is turned together with the protruding member 91. The blade 82 and the protruding member 91 are provided on the holder 92 in a posture inclined with respect to the left-and-right direction so that the waste liquid W flows in one of the left and right directions. In the illustrated example, the blade 82 is inclined such that the left end portion is positioned slightly rearward from the right end portion, but may be inclined in the opposite direction.

[First Biasing Member] The first biasing member 93 (see FIG. 11 and FIG. 12) is, for example, a torsion coil spring, and is wound around the shaft portion 91S. One end of the first biasing member 93 is engaged with the holder 92, and the other end is engaged with the protruding member 91. The first biasing member 93 biases the protruding member 91 in the counterclockwise direction in FIG. 9 and FIG. 10 and in the clockwise direction in FIG. 11. In other words, the first biasing member 93 biases the blade 82 in a direction in which the tip end portion of the blade 82 is pressed against the nozzle surface 14F. The first biasing member 93 may be a plate spring, a compression coil spring, or the like.

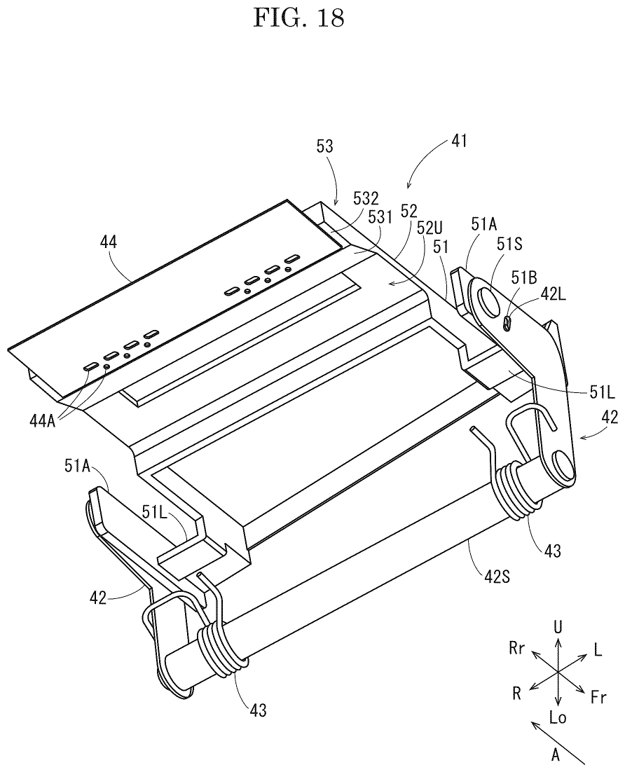

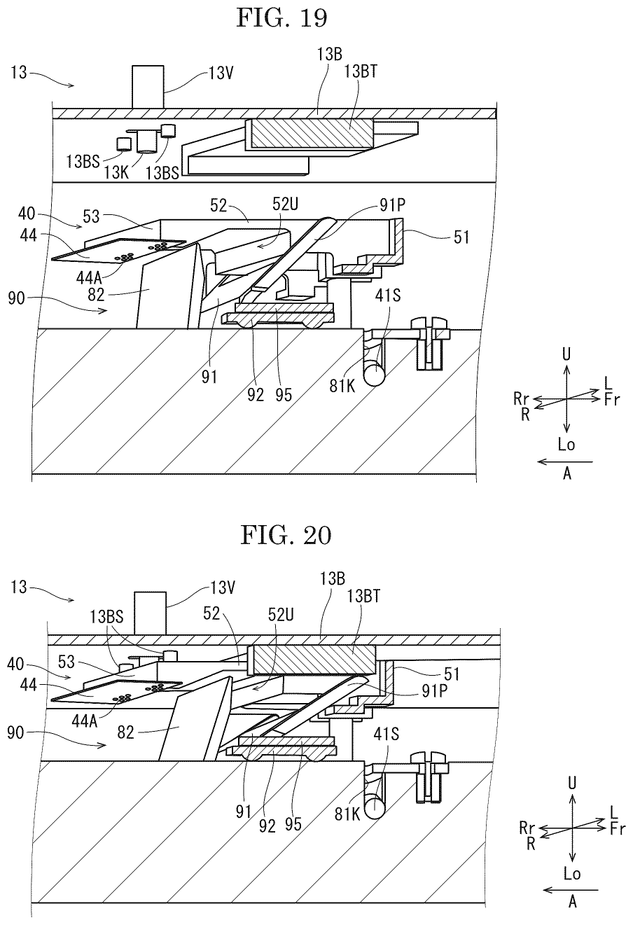

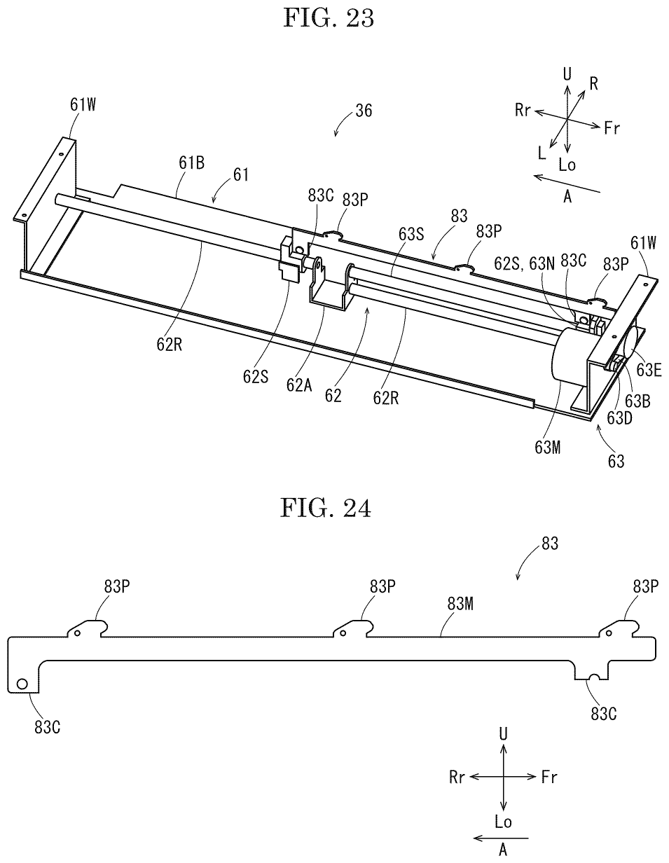

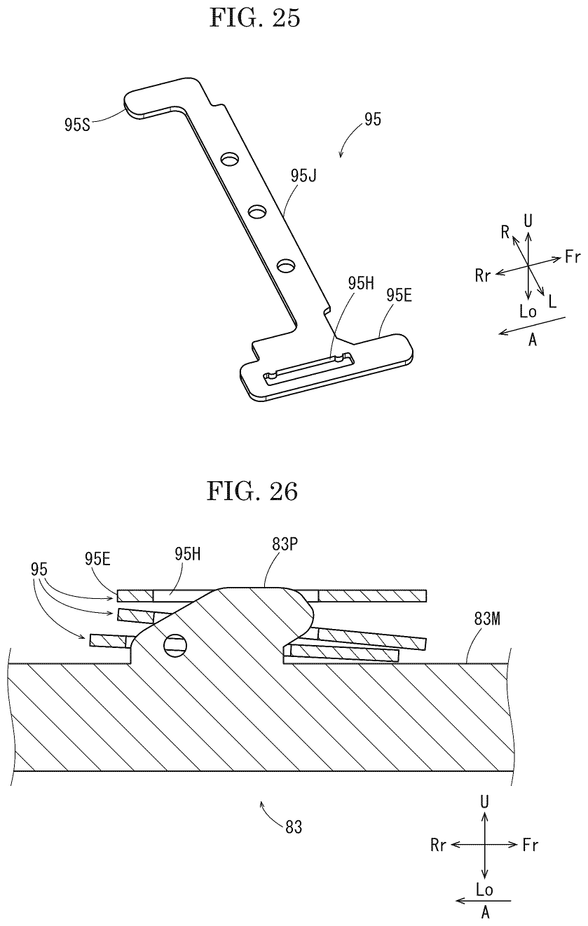

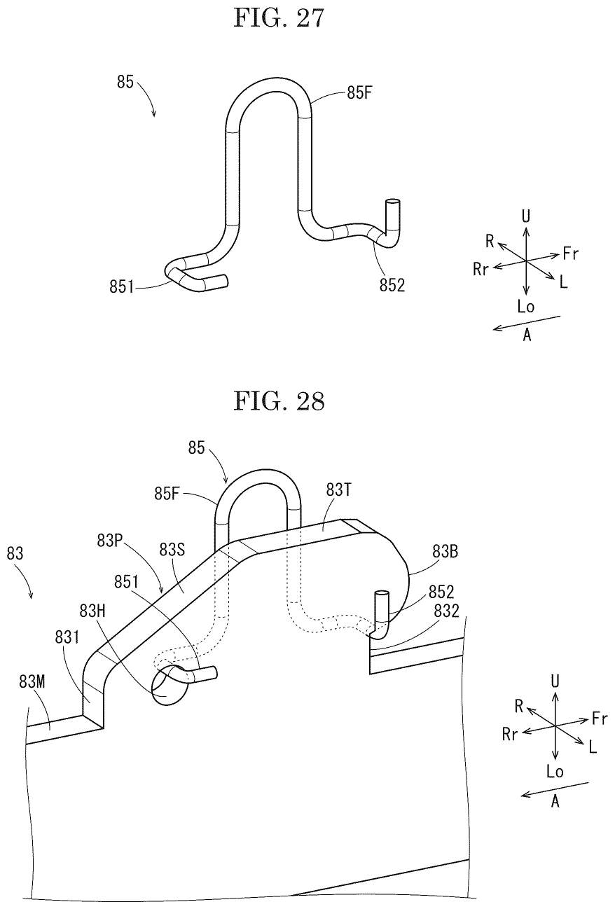

FIG. 23 is a perspective view showing a blade sliding device 36. FIG. 24 is a left side view showing the support 83. FIG. 25 is a perspective view showing the engagement member 95. FIG. 26 is a cross-sectional view showing a change in posture of the engagement member 95 when attached and detached to and from a projection portion 83P. FIG. 27 is a perspective view showing a restriction member 85. FIG. 28 is a perspective view showing a state in which the restriction member 85 is attached to the projection portion 83P.

[Engagement Member] The engagement member 95 (see FIG. 25) is provided in the holder 92 (see FIG. 9, FIG. 10, FIG. 15 to 17, FIG. 19 and FIG. 20). Although the engagement members 95 provided on the right two blade units 90 of the three blade units 90 will be described here, the engagement member 95 provided on the left one blade unit 90 have the same configuration as the right engagement members 95 except that the shape is reversed in the left-and-right direction.

The engagement member 95 has a joint portion 95J, an engagement portion 95E, a through-hole 95H, and a slide portion 95S. The joint portion 95J is an elongated plate-like portion whose longitudinal direction is along the left-and-right direction, and is joined to a portion in front of the protruding member 91 on the upper portion of the holder 92. The engagement portion 95E is provided at the left end of the joint portion 95J. The engagement portion 95E has the through-hole 95H penetrating in the upper-and-lower direction. The through-hole 95H is a long hole whose longitudinal direction is along the front-and-rear direction. The slide portion 95S is provided at the right end of the joint portion 95J. The slide portion 95S has a larger dimension in the front-and-rear direction than the joint portion 95J, and slides with respect to the upper surface of the edge of the recess 81U of the waste liquid tray 81 when the blade unit 90 slides.

[Support] The support 83 (see FIG. 23 and FIG. 24) is formed in an elongated plate shape whose thickness direction is along the left-and-right direction and whose longitudinal direction is along the front-and-rear direction. The support 83 is housed in the slit 81S (see FIG. 7, FIG. 8, FIG. 10 and FIG. 15). A length of the support 83 in the front-and-rear direction is shorter than a length of the slit 81S in the front-and-rear direction. The support 83 is slidable in the front-and-rear direction along the slit 81S.

The support 83 has a body portion 83M, connection portions 83C, and projection portions 83P. The body portion 83M is a rectangular portion whose longitudinal direction is along the front-and-rear direction. The connection portions 83C protrude downward from both front and rear end portions of the body portion 83M. The three projection portions 83P are provided on the upper edge of the body portion 83M at approximately equal intervals in the front-and-rear direction. The projection portion 83P protrudes upward, and is inclined forward with respect to the vertical direction. The three blade units 90 are engaged with the projection portions 83P of the support 83 through the through-hole 95H of the engagement member 95.

The projection portion 83P has a first upright portion 831, a second upright portion 832, an inclined portion 83S, a top portion 83T, a bulging portion 83B, and a hole portion 83H. The first upright portion 831 and the second upright portion 832 are upright from the upper edge portion of the body portion 83M. The second upright portion 832 is positioned in front of the first upright portion 831. The inclined portion 83S is provided above the upper end of the first upright portion 831. The inclined portion 83S is inclined so that the front side is higher than the rear side. The top portion 83T is provided substantially horizontally forward from the upper end portion of the inclined portion 83S. The position of the front end portion of the top portion 83T in the front-and-rear direction is substantially the same as that of the second upright portion 832. The bulging portion 83B is a portion connecting the front end portion of the top portion 83T and the upper end portion of the second upright portion 832, and bulges forward. The projection portion 83P has the hole portion 83H penetrating in the left-and-right direction (the width direction of the blade 82). The hole portion 83H is provided between the first upright portion 831 and the second upright portion 832 at a position closer to the first upright portion 831.

[Restriction Member] The restriction member 85 (see FIG. 27 and FIG. 28) has a first engagement portion 851, a second engagement portion 852, and a flexible portion 85F. The first engagement portion 851 is engaged with the hole portion 83H. The second engagement portion 852 is engaged with the inclined side root of the projection portion 83P. The inclined side root is a boundary between the second upright portion 832 and the bulging portion 83B. The flexible portion 85F is a portion connecting the first engagement portion 851 and the second engagement portion 852, and has flexibility. In the restriction member 85, at least the flexible portion 85F is formed by bending a wire made of metal, for example, and the flexible portion 85F can be easily bent in a direction in which the second engagement portion 852 is separated from the first engagement portion 851. A width of the restriction member 85 in the left-and-right direction is wider than the through-hole 95H of the engagement member 95. When the restriction member 85 is attached to the projection portion 83P, the first engagement portion 851 and the second engagement portion 852 protrude leftward from the left end portion of the through-hole 95H (see FIG. 15), and the flexible portion 85F protrudes rightward from the right end portion of the through-hole 95H (not shown).

[Blade Sliding Device] The waste liquid tray 81 is provided with the blade sliding device 36 (see FIG. 4 and FIG. 23). The blade sliding device 36 slides the support 83 along the slit 81S so that the blade unit 90 is slid in the front-and-rear direction. The blade sliding device 36 includes a frame body 61, a guide part 62, and a feed screw 63.

The frame body 61 has a bottom portion 61B and wall portions 61W. The bottom portion 61B is a generally rectangular plate-like portion whose thickness direction is along the upper-and-lower direction and whose longitudinal direction is along the front-and-rear direction. The wall portions 61W each having a plate-like shape whose thickness direction is along the front-and-rear direction stand upward from both front and rear ends of the bottom portion 61B.

The guide part 62 includes rails 62R, a support member 62A, and sliding members 62S. The support member 62A is provided substantially at the center of the bottom portion 61B in the front-and-rear direction. One rail 62R is provided between the front wall portion 61W and the support member 62A, and another rail 62R is provided between the rear wall portion 61W and the support member 62A. The two rails 62R are respectively provided with the sliding members 62S. The sliding member 62S is slidable along the rail 62R. The two sliding members 62S are connected to the front and rear connection portions 83C of the support 83.

The feed screw 63 includes a screw shaft 63S, a nut 63N, a motor 63M, a driving pulley 63D, a driven pulley 63E, and a timing belt 63B. The screw shaft 63S is provided between the front wall portion 61W and the support member 62A. The nut 63N is integrated with the front sliding member 62S. The driving pulley 63D is provided on the motor 63M, the driven pulley 63E is provided on the screw shaft 63S, and the timing belt 63B is wound around the driving pulley 63D and the driven pulley 63E. The driving force of the motor 63M is transmitted to the screw shaft 63S through the driving pulley 63D, the timing belt 63B, and the driven pulley 63E, and the nut 63N is moved by the rotation of the screw shaft 63S. With the movement of the nut 63N, the sliding member 62S slides along the rail 63R, and the support 83 slides in the front-and-rear direction.

FIG. 7 shows a state where the blade unit 90 is positioned at a wiping operation start position. In the wiping operation start position, the support 83 is positioned frontmost, and the three blade units 90 are positioned in front of the nozzle surface 14F. FIG. 8 shows a state where the blade unit 90 is positioned at the wiping operation end position. At the wiping operation end position, the support 83 is positioned rearmost, and the three blade units 90 are positioned on the rear side of the nozzle surface 14F.

[Engagement of Blade Unit to Support] The blade unit 90 is attached to the support 83 by engaging the engagement portion 95E (the through-hole 95H) of the engagement member 95 with the projection portion 83P of the support 83. On the other hand, the blade unit 90 is detached from the support 83 by pulling out the engagement portion 95E from the projection portion 83P. Since the projection portion 83P is inclined forward, the attachment and detachment of the blade unit 90 is performed while tilting the blade unit 90 forward, but the work load is substantially the same as that in the case where the projection portion 83P is upright.

When an external force containing an upward component acts on the blade unit 90, the bulging portion 83B of the projection portion 83P resists the upward movement of the blade unit 90, so that the blade unit 90 hardly falls off or floats.

In this embodiment, since the center of gravity of the blade unit 90 is deviated rearward (that is, forward in the moving direction A) with respect to the projection portion 83P, gravity acts in a direction to incline the blade unit 90 forward in the moving direction A. Therefore, in the case where the projection portion 83P is upright, there is a risk that the blade unit 90 floats forward in the moving direction A. On the other hand, in the projection portion 83P of the present embodiment, since the bulging portion 83B of the projection portion 83P resists the load in the direction to incline the blade unit 90, the inclination of the blade unit 90 can be suppressed.

After the engagement portion 95E is engaged with the projection portion 83P, the restriction member 85 is attached. A width of the restriction member 85 in the left-and-right direction is wider than the through-hole 95H of the engagement member 95. When the restriction member 85 is attached to the projection portion 83P, the first engagement portion 851 and the second engagement portion 852 protrude leftward from the left end portion of the through-hole 95H (see FIG. 15), and the flexible portion 85F protrudes rightward from the right end portion of the through hole 95H (not shown). Therefore, the blade unit 90 can surely be prevented from falling and floating.

When the restriction member 85 is attached, after the first engagement portion 851 is engaged with the hole portion 83H of the projection portion 83P, the flexible portion 85F is expanded in a direction in which the second engagement portion 852 is separated from the first engagement portion 851, and the second engagement portion 852 is engaged with the inclined side root of the projection portion 83P. When the restriction member 85 is detached, the flexible portion 85F is expanded to remove the second engagement portion 852 from the inclined side root of the projection portion 83P, and then the first engagement portion 851 is pulled out from the hole portion 83H. According to the present embodiment, the restriction member 85 can be easily attached and detached.

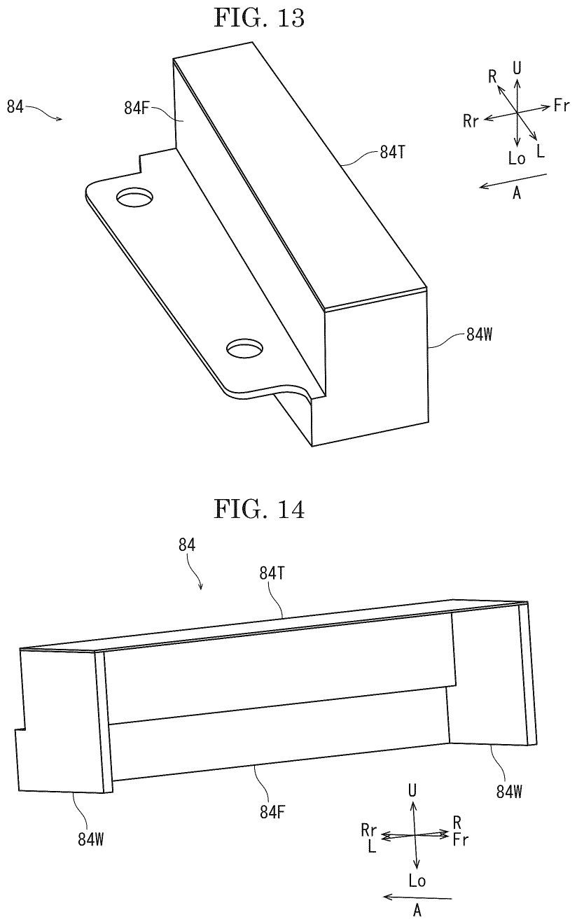

Further, in the present embodiment, since the plurality of blade units 90 are arranged in the staggered pattern on both left and right sides of the support 83, the deviation of the mass of the blade units 90 can be reduced, and the support 83 can be smoothly slid.

[Receiving Member] FIG. 13 and FIG. 14 are perspective views showing the receiving member 84. The receiving member 84 is attached to the waste liquid tray 81 (see FIG. 7, FIG. 8 and FIG. 10). The receiving member 84 is provided at the rear end of each of the three recesses 81U. The receiving member 84 includes a front surface portion 84F facing the rear surface of the blade 82, a ceiling portion 84T provided forward from the upper end portion of the front surface portion 84F, and side wall portions 84W provided forward from both right and left ends of the front surface portion 84F. That is, the receiving member 84 is formed in a box shape in which the front side and the lower side are opened.

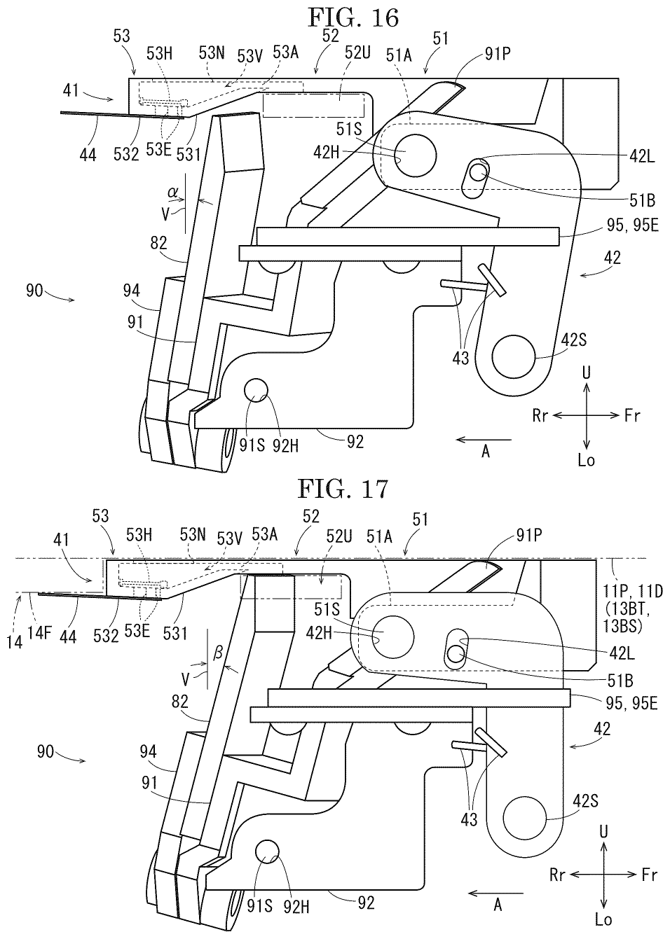

When the blade unit 90 reaches the wiping operation end position, the blade 82 is housed in the receiving member 84. At this time, the blade 82 is surrounded by the receiving member 84 from the rear, upper, right and left sides. Either the ceiling portion 84T or the side wall portion 84W may be provided.

[Cleaning Liquid Supply Part] FIG. 16 and FIG. 17 are perspective views showing the cleaning liquid supply part 40 and the blade unit 90. FIG. 18 is a perspective view showing the cleaning liquid supply part 40. FIG. 19 to FIG. 22 are perspective views showing a cross section of the cleaning liquid supply part 40 and the cleaning liquid supply source 13. The cleaning liquid supply part 40 includes a supply member 41, link members 42, and a delivery member 44.

[Supply Member] The supply member 41 has a base end part 51, an intermediate part 52, and a storage part 53 in this order from the front side. The upper surface of the supply member 41 is flat and rectangular when viewed from the upper side. The front portion of the parallel surface 11P of the head base 11b (see FIG. 6) in front of the nozzle plate 14 faces the upper surface of the supply member 41, and also serves as a pushing down part 11D which pushes down the supply member 41. The pushing down part 11D may be provided as a member separate from the head base 11B.

On the light side surface and the left side surface of the base end part 51, arm support portions 51L protruding leftward and rightward are provided, respectively (see FIG. 18). The left and right arm support portions 51L each has an arm portion 51A protruding forward (see FIG. 16 to FIG. 18). Shaft portion 51S protrudes from the left side surface of the left arm portion 51A and from the right side surface of the right arm portion 51A, respectively. Bosses 51B are provided on the rear side of the right and left shaft portions 51S, respectively.

A thickness of the intermediate part 52 in the upper-and-lower direction is thinner than that that of the base end part 51 (see FIG. 16 to FIG. 18). The lower surface of the intermediate part 52 is flat. The lower surface of the storage part 53 has a first inclined surface 531 and a second inclined surface 532 provided on the rear side of the first inclined surface 531. The first inclined surface 531 is inclined so that the front side is higher than the rear side (see FIG. 16 and FIG. 17). The second inclined surface 532 is inclined so that the front side is lower than the rear side. The first inclined surface 531 is continuous with the lower surface of the intermediate part 52. Therefore, a larger space (hereinafter, it is referred to as a non-contact space 52U) is formed below the intermediate part 52 than a space below the storage part 53.

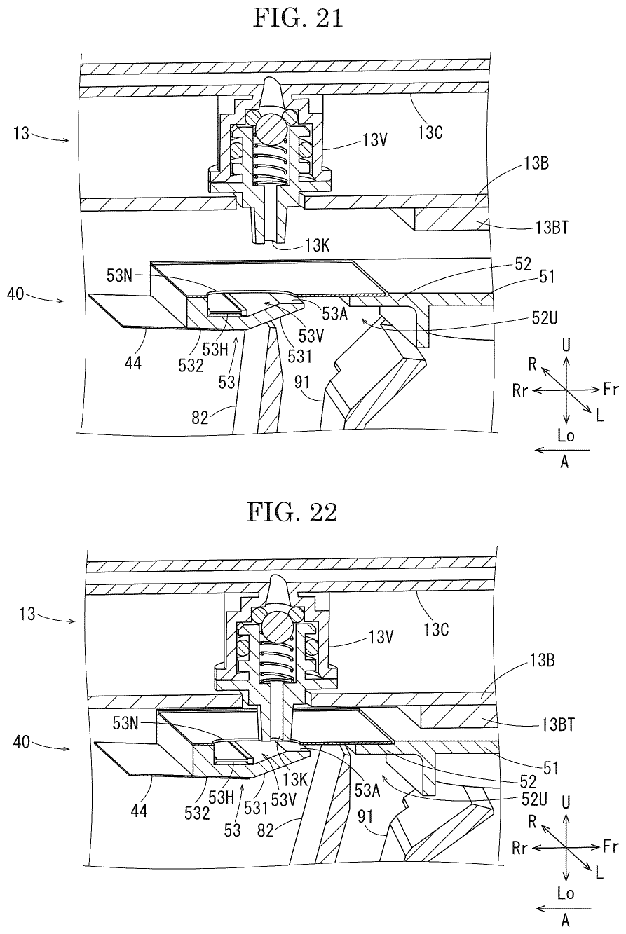

The storage part 53 has a hollow structure having a storage space 53V in which the cleaning liquid is stored (see FIG. 16 and FIG. 17). Preferably, a cleaning liquid holding member 53H (see FIG. 21 and FIG. 22) which holds the cleaning liquid, such as a net-like member or a porous member, is provided in the storage space 53V. On the upper surface of the storage part 53, an intake port 53N (see FIG. 15, FIG. 21 and FIG. 22) through which the cleaning liquid is taken in is provided. On the lower surface of the storage part 53, a discharge port 53E (see FIG. 16 and FIG. 17) through which the cleaning liquid is discharged is provided. A thickness of the rear end portion of the storage part 53 in the upper-and-lower direction (a distance from the rear end portion of the second inclined surface 532 to the upper surface) is slightly larger than a distance from the lower surface of the head base 11B to the nozzle surface 14F. An opening 53A penetrating in the front- and rear direction is provided at the front end portion of the storage space 53V. The opening 53A is provided at the upper end portion of the first inclined surface 531.

[Link Member] The link members 42 are provided on the left and right sides of the supply member 41, respectively (FIG. 15 to FIG. 18). The lower portions of the left and right link members 42 are connected by a shaft 42S (see FIG. 18) whose longitudinal direction is along the left-and-right direction. The shaft 42S is rotatably supported by the recess 81U of the waste liquid tray 81. Specifically, the waste liquid tray 81 has notches 81K extending downward from the upper ends of the right and left side walls of the recess 81U (see FIG. 19 and FIG. 20). Both left and right end portions of the shaft 42S are supported by the notches 81K. The link member 42 is turnable around the shaft 42S.

The upper portions of the left and right link members 42 have shaft holes 42H into which the shaft portions 51S of the supply member 41 are inserted, respectively (see FIG. 16 to FIG. 18). The shaft hole 42H is disposed on the rear side of the shaft 42S. A long hole 42L into which the boss 51B of the supply member 41 is inserted is provided in front of the shaft hole 42H. The supply member 41 is turnable with respect to the link member 42 around the shaft portions 51S within a range in the longitudinal direction of the long hole 42L (see FIG. 16 and FIG. 17).

[Second Biasing Member] The link member 42 is provided with a second biasing member 43 (see FIG. 18). Specifically, the second biasing member 43 is a torsion coil spring, and is wound around the shaft 42S. One end of the second biasing member 43 is engaged with the holder 92, and the other end is engaged with the link member 42 (see FIG. 16 and FIG. 17). The second biasing member 43 biases the link member 42 in the clockwise direction in FIG. 16 and FIG. 17. In other words, the second biasing member 43 biases the supply member 41 in a direction closer to the inkjet head 12. The second biasing member 43 may be a plate spring, a compression coil spring, or the like.

[Delivery Member] The delivery member 44 is joined on the second inclined surface 532. The delivery member 44 has the same inclination angle as the second inclined surface 532. The delivery member 44 is a rectangular sheet-like member made of resin or the like, and has flexibility. The rear end portion of the delivery member 44 protrudes rearward from the rear end portion of the storage part 53. The delivery member 44 is provided with a discharge port 44A at a position corresponding to the discharge port 53E of the storage part 53 (see FIG. 18).

[Cleaning Liquid Supply Source] The cleaning liquid supply source 13 (see FIG. 7) supplies the cleaning liquid to the supply member 41. The cleaning liquid is a liquid containing water as a main component. The cleaning liquid supply source 13 includes a tank 13T, a pump 13P, a supply flow pass 13C, and a support plate 13B. The cleaning liquid is stored in the tank 13T. The supply flow pass 13C is branched into three on the downstream side of the pump 13P. Each of the branched supply flow passes 13C is connected to a valve 13V. The valve 13V is, for example, a check valve. The three valves 13V are disposed above the intake ports 53N of the supply member 41. The supply flow passes 13C and the valves 13V are supported by the support plate 13B. The valve 13V passes through the support plate 13B, and the discharge port 13K of the valve 13V protrudes from the lower surface of the support plate 13B.

Supply source lifting devices 13L (see FIG. 7) are provided on the front side and the rear side of the support plate 13B, respectively. The supply source lifting device 13L is constituted of, for example, a cam mechanism and a ball screw. The supply source lifting devices 13L lift and lower the support plate 13B to a supply position (see FIG. 23A) and a retracted position (see FIG. 23B). The supply position is a position where the discharge ports 13K of the valves 13V are inserted into the intake ports 53N (see FIG. 20 and FIG. 22). The retracted position is a position where the discharge ports 13K of the valves 13V are retracted upward from the intake ports 53N (see FIG. 19 and FIG. 21).

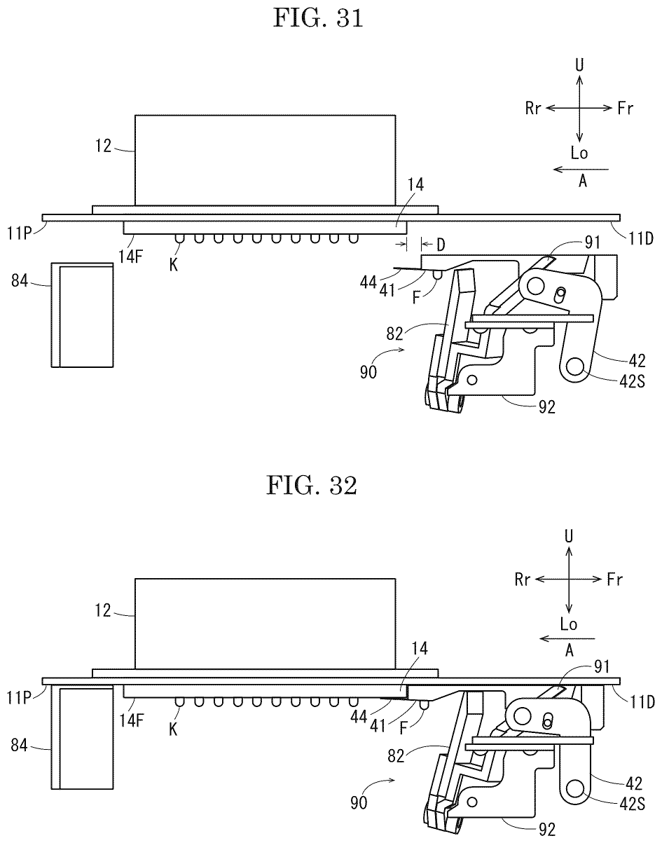

On the lower surface of the support plate 13B, a protrusion 13BT protruding downward is provided at a position corresponding to the protruding portion 91P of the protruding member 91 (see FIG. 19 to FIG. 22). On the lower surface of the support plate 13B, protrusions 13BS protruding downward are provided on the left and right sides of the valve 13V, respectively (see FIG. 19 and FIG. 20).

[Outline of Operation of Wipe Unit] Next, an outline of the operation of the wipe unit 32 will be described. FIG. 31 to FIG. 36 are left side views showing the operation of the wipe unit 32. Here, the outline of the operation of the wipe unit 32 will be described, and the operations of the protruding member 91 and the supply member 41 will be described later.

Hereinafter, the state shown in FIG. 29A and FIG. 30A will be described as the initial state. In the initial state, the head unit 11 is positioned at the image forming position (see FIG. 29A), the cap unit 31 is positioned at the home position, the wipe unit 32 is positioned at the home position and the contact position, and the cleaning liquid supply source 13 is positioned at the supply position. The blade 82 is positioned at the wiping operation start position (see FIG. 30A). A predetermined amount of the cleaning liquid is supplied from the cleaning liquid supply source 13 to the cleaning liquid supply part 40. The control part 2 performs the following processing at a predetermined timing. The predetermined timing is, for example, a timing in which an increase of a viscosity of the ink in the nozzle 14N is expected, and more specifically, a case in which a period in which the image forming job is not executed continues for a predetermined period.

First, the control part 2 operates the head lifting devices 11L to lift the head unit 11 to the retracted position (see FIG. 29B). Further, the control part 2 operates the supply source lifting devices 13L to lift the cleaning liquid supply source 13 to the retracted position (see FIG. 29B).

Next, the control part 2 operates the cap sliding devices 34 to slide the cap unit 31 to the maintenance position (see FIG. 29C, FIG. 30B and FIG. 31). At this time, since the wipe unit 32 is placed on the cap unit 31, the wipe unit 32 slides to the maintenance position together with the cap unit 31. Next, the control part 2 operates the head lifting devices 11L to lower the head unit 11 to a height (hereinafter, it is referred to as a wiping position) at which the wiping operation is performed (see FIG. 29D and FIG. 32).

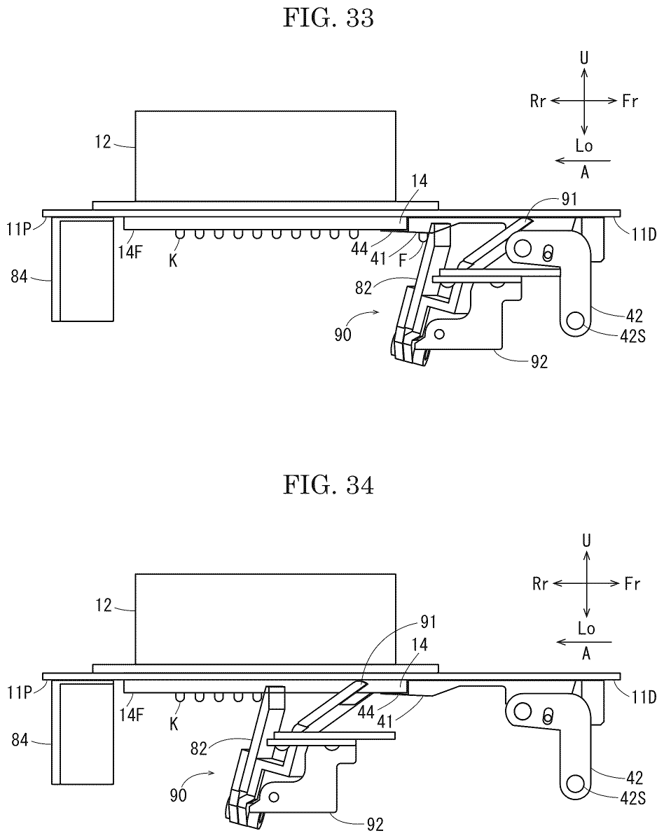

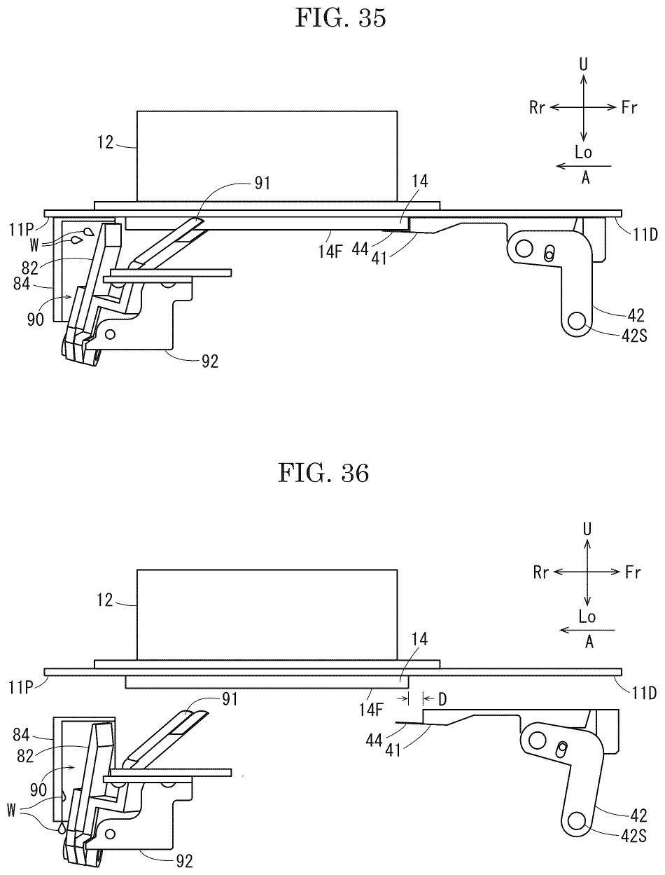

Next, after the control part 2 operates the inkjet head 12 to eject a predetermined amount of the ink from the inkjet head 12, the control part 2 operates the blade sliding device 36 to slide the blade 82 rearward (the moving direction A) along the nozzle surface 14F (see FIG. 30C). The blade 82 scrapes the cleaning liquid F swelling from the ejection ports 44A (see FIG. 33) and slides along the nozzle surface 14F (see FIG. 34 and FIG. 35). On the nozzle surface 14F, the remaining ink K is diluted by the cleaning liquid F carried by the blade 82. The waste liquid W containing the remaining ink K and the cleaning liquid F is scraped by the blade 82 and falls into the recess 81U.

Next, the control part 2 operates the head lifting devices 11L to lift the head unit 11 to the retracted position (see FIG. 29C and FIG. 36). Next, the control part 2 operates the blade sliding device 36 to return the blade 82 to the wiping operation start position (see FIG. 30B and FIG. 31). Next, the control part 2 operates the cap sliding devices 34 to slide the cap unit 31 and the wipe unit 32 to the home position (see FIG. 29B and FIG. 30A).

Next, the control part 2 operates the wipe lifting devices 35 to lift the wipe unit 32 to the separated position (see FIG. 29E). Next, the control part 2 operates the cap sliding devices 34 to slide the cap unit 31 to the maintenance position (see FIG. 29F and FIG. 30D). At this time, since the wipe unit 32 is separated from the cap unit 31, the wipe unit 32 remains at the home position and only the cap unit 31 slides to the maintenance position.

Next, the control part 2 operates the head lifting devices 11L to lower the head unit 11 to a height (hereinafter, it is referred to as a capping position) at which the nozzle surface 14F is in contact with the cap 72 (see FIG. 29G). Thus, the cap 72 is attached on the nozzle surface 14F.

When the image forming job is executed, the control part 2 operates the head lifting devices 11L to lift the head unit 11 to the retracted position (see FIG. 29F), operates the cap sliding device 34 to slide the cap unit 31 to the home position (see FIG. 29E), and operates the wipe lifting devices 35 to lower the wipe unit 32 to the contact position (see FIG. 29B). Then, the control part 2 operates the head lifting devices 11L to lower the head unit 11 to the image forming position (see FIG. 29A), and executes the image forming job.

[Operations of Protruding Member and Supply Member] Next, the operations of the protruding member 91 and the supply member 41 will be described. FIG. 16 shows a state in which the protruding member 91 and the supply member 41 are not pushed down (hereinafter, it is referred to as a non-pushed down state). On the other hand, FIG. 17 shows a state in which the protruding member 91 is pushed down by the parallel surface 11P or the protrusion 13BT and the supply member 41 is pushed down by the pushing down part 11D or the protrusion 13BS (hereinafter, it is referred to as a pushed down state). The first biasing member 93 biases the protruding member 91 in the counterclockwise direction in FIG. 16 and FIG. 17. The second biasing member 43 biases the link member 42 in the clockwise direction.

[Non-pushed Down State] When the wipe unit 32 is positioned at the home position and the cleaning liquid supply source 13 is lifted to the retracted position, it is turned to the non-pushed down state (see FIG. 19, FIG. 21, FIG. 29B, FIG. 29E, FIG. 29F and FIG. 29G). In addition, when the wipe unit 32 is positioned at the maintenance position and the head unit 11 is lifted to the retracted position, it is turned to the non-pushed down state (see FIG. 29C).

[Pushed Down State] On the other hand, when the wipe unit 32 is positioned at the home position and the cleaning liquid supply source 13 is lowered to the supply position, it is turned to the pushed down state (see FIG. 20, FIG. 22 and FIG. 29A). Specifically, when the cleaning liquid supply source 13 is lowered (see FIG. 17, FIG. 20 and FIG. 22) from the non-pushed down state (see FIG. 16, FIG. 19 and FIG. 21), the protrusion 13BT pushes down the protruding portion 91P against the first biasing member 93, and the protrusion 13BS pushes down the supply member 41 against the second biasing member 43. At this time, the discharge port 13K of the valve 13V is inserted into the intake port 53N of the supply member 41 (see FIG. 22), and it becomes possible to supply the cleaning liquid from the cleaning liquid supply source 13 to the cleaning liquid supply part 40.

Also, when the wipe unit 32 is positioned at the maintenance position and the head unit 11 is lowered to the wiping position, it is turned to the pushed down state (see FIG. 29D). When the head unit 11 is lowered (see FIG. 17) from the non-pushed down state (see FIG. 16), the parallel surface 11P pushes down the protruding portion 91P against the first biasing member 93, and the pushing down part 11D pushes down the supply member 41 against the second biasing member 43.

When it is transited from the non-pushed down state to the pushed down state, the protruding portion 91P is pushed down to turn the blade 82 in the clockwise direction. Therefore, an inclination angle R of the front surface of the blade 82 with respect to the vertical line V in the pushed down state (see FIG. 17) is larger than an inclination angle α in the non-pushed down state (see FIG. 16). When the supply member 41 is pushed down, the link member 42 is turned in the counterclockwise direction. Therefore, in the pushed down state, the supply member 41 moves rearward and downward as compared with the non-pushed down state.

When focusing on the tip end portion of the blade 82, in the non-pushed down state, the tip end portion of the blade 82 is positioned below the first inclined surface 531 of the supply member 41. On the other hand, in the pushed down state, the tip end portion of the blade 82 is moved forward and downward, and the supply member 41 is moved rearward and downward, but the tip end portion of the blade 82 enters the non-contact space 52U below the intermediate part 52 of the supply member 41, so that interference between the blade 82 and the supply member 41 is avoided.

[Wiping Operation] Next, the wiping operation will be described in detail. When the head unit 11 is lifted to the retracted position and the wipe unit 32 is slid to the maintenance position (see FIG. 29C, FIG. 30B and FIG. 31), the protruding member 91 and the supply member 41 are in the non-pushed down state (see FIG. 16). At this time, the front end surface of the nozzle plate 14 and the rear end surface of the supply member 41 are spaced apart in the front-and-rear direction by a distance D (see FIG. 31). The cleaning liquid F is swollen from the discharge port 44A (see FIG. 18) of the delivery member 44 (see FIG. 31). The remaining ink K adheres to the nozzle surface 14F (see FIG. 31).

Next, the control part 2 operates the head lifting devices 11L to lower the head unit 11 to the wiping position (see FIG. 29D and FIG. 32). Then, since the parallel surface 11P pushes down the protruding member 91 and the supply member 41, the protruding member 91 and the supply member 41 are in the pushed down state (see FIG. 17). At this time, the blade 82 is turned from the inclination angle α to the inclination angle 3. Since the supply member 41 is moved rearward, a distance between the rear end surface of the supply member 41 and the front end surface of the nozzle plate 14 is decreased. At this time, the rear end surface of the supply member 41 may be in contact with the front end surface of the nozzle plate 14. In addition, since the delivery member 44 is moved below the nozzle surface 14F and at least the rear end portion of the upper surface of the delivery member 44 comes into contact with the nozzle surface 14F, a step between the second inclined surface 532 and the nozzle surface 14F is eliminated.

Next, the control part 2 operates the inkjet head 12 to eject a predetermined amount of the ink from the inkjet head 12. By this operation, the ink having increased viscosity is discharged from the nozzle 14N. Next, the control part 2 operates the blade sliding device 36 to slide the blade 82 rearward (the moving direction A) along the nozzle surface 14F. The blade 82 scrapes the cleaning liquid F swelling from the discharge port 44A (see FIG. 33), moves along the lower surface of the delivery member 44 to the nozzle surface 14F, and then moves rearward (the moving direction A) along the nozzle surface 14F (see FIG. 34). In FIG. 33 and FIG. 34, the tip end portion of the blade 82 overlaps the supply member 41 and the nozzle plate 14, but actually, the tip end portion of the blade 82 is bent forward.

When the blade 82 slides along the nozzle surface 14F, since the blade 82 slides in a state where the protruding member 91 is in contact with the parallel surface 11P, an inclination angle of the blade 82 is kept constant. Therefore, the blade 82 is pressed against the nozzle surface 14F with a constant load. The blade 82 is pressed against the nozzle surface 14F mainly by the elastic force of the first biasing member 93. The elastic force of the first biasing member 93 is adjusted so as to minimize the deflection of the blade 82.

On the nozzle surface 14F, the remaining ink K is diluted by the cleaning liquid F carried by the blade 82. The waste liquid containing the remaining ink K and the cleaning liquid F is scraped off by the blade 82 and flows down along the front and rear surfaces of the blade 82. The waste liquid W flowing down along the front surface of the blade 82 passes through the through-hole 91A of the protruding member 91, and falls into the recess 81U (see FIG. 11). The waste liquid W flowing down along the rear surface of the blade 82 passes through the rear surface of the fixing member 94, is collected in the center in the left-and-right direction along the lower edge portion of the fixing member 94 and the lower edge portion of the protruding member 91, and falls into the recess 81U.

In parallel with the blade 82 passing through the rear end portion of the nozzle surface 14F (see FIG. 35), the control part 2 operates the head lifting devices 11L to lift the head unit 11 to the retracted position (see FIG. 29C and FIG. 36). At this time, since the head base 11B is also lifted, the protruding member 91 and the supply member 41 return to the non-pushed down state. Further, since the blade 82 is separated from the nozzle surface 14F, the inclination angle of the blade 82 is returned to the inclination angle α and the deflection deformation of the blade 82 is eliminated. By this operation, the waste liquid W is discharged from the blade 82 toward the receiving member 84. The waste liquid W received by the receiving member 84 flows down along the inner surface of the receiving member 84 and falls into the recess 81U.

If the structure (the protruding member 91, the holder 92, the first biasing member 93, and the others) for changing the inclination angle of the blade 82 is not provided, the blade 82 is pressed against the nozzle surface 14F exclusively by the elastic force due to the deflection deformation of the blade 82 itself. Therefore, when the tip end portion of the blade 82 passes through the rear end portion of the nozzle surface 14F, the deflection of the blade 82 is rapidly returned, and there is a possibility that the waste liquid W is scattered. On the other hand, in the present embodiment, the deflection of the blade 82 is suppressed to be smaller than in the case where the structure for changing the inclination angle of the blade 82 is not provided. Further, since the recovery of the inclination of the blade 82 is performed in parallel with the elimination of the deflection deformation, the waste liquid W is mainly discharged forward and received by the receiving member 84, thereby suppressing the scattering of the waste liquid W.

The maintenance device 30 according to the present embodiment described above includes: the blade unit 90 including the blade 82 in contact with the nozzle surface 14F of the inkjet head 12; the support 83 to which the blade unit 90 is detachably attached; and the blade sliding device 36 which slides the support 83 in the predetermined moving direction A along the nozzle surface 14F. The blade unit 90 has the through-hole 95H penetrating in the upper-and-lower direction, the support 83 includes the projection portion 83P engaging with the through-hole 95H, the projection portion 83P protrudes upward and is inclined to the upper-and-lower direction. According to the present embodiment, the blade unit 90 can be easily attached and detached, and the blade unit 90 can be hardly fallen or lifted up.

According to the maintenance device 30 according to the present embodiment, the center of gravity of the blade unit 90 is deviated forward or rearward in the moving direction A with respect to the projection portion 83P, and the projection portion 83P is inclined in the direction opposite to the deviation direction of the center of gravity. According to the present embodiment, the lifting of the blade unit 90 can be suppressed by resisting the load in the direction of tilting the blade unit 90.

In addition, according to the maintenance device 30 according to the present embodiment, the restriction member 85 is provided, which is attached to the upwardly exposed portion of the projection portion 83P above the through-hole 95H to restrict the upward movement of the blade unit 90. According to the present embodiment, the blade unit 90 can be reliably prevented from falling off and floating.

According to the maintenance device 30 according to the present embodiment, the projection portion 83P includes the hole portion 83H penetrating in the width direction of the blade 82, and the restriction member 85 includes the first engagement portion 851 engaging with the hole portion 83H, the second engagement portion 852 engaging with the inclined side root of the projection portion 83P, and the flexible portion 85F having flexibility and connecting the first engagement portion 851 and the second engagement portion 852. According to the present embodiment, the restriction member 85 can be easily attached and detached.

The maintenance device 30 according to the present embodiment includes the waste liquid tray 81 having the slit 81S which guides the support 83 along the moving direction A, and the plurality of recesses 81U arranged in a staggered pattern on both sides of the slit 81S in the direction crossing the moving direction A and each housing the blade unit 90. The support 83 includes the plurality of projection portions 83P having the same number as the recesses 81U. According to the present embodiment, since the plurality of blade units 90 are arranged in a staggered pattern on both sides of the support 83, the deviation of the mass of the blade units 90 can be reduced, and the support 83 can be smoothly slid.

The inkjet recording apparatus 1 according to the present embodiment includes the maintenance device 30 and the inkjet head 12. According to the present embodiment, the clogging of the nozzle surface 14F of the inkjet head 12 can be suppressed.

1. A maintenance device comprising:
a blade unit which includes a blade in contact with a nozzle surface of an inkjet head;
a support to which the blade unit is detachably attached; and
a blade sliding device which slides the support to a predetermined moving direction along the nozzle surface, wherein
the blade unit has a through-hole penetrating in an upper-and-lower direction,
the support has a projection portion which is engaged with the through-hole, and
the projection portion protrudes upward and is inclined with respect to a vertical direction.

2. The maintenance device according to claim 1, wherein
a center of gravity of the blade unit is deviated forward or rearward in the moving direction with respect to the projection portion, and
the projection portion is inclined in an opposite direction to a deviation direction of the center of gravity.

3. The maintenance device according to claim 1, comprising:
a restriction member which is attached to an upwardly exposed portion of the projection portion above the through-hole to restrict an upward movement of the blade unit.

4. The maintenance device according to claim 3, wherein
the projection portion has a hole portion penetrating in a width direction of the blade,
the restriction member includes:
a first engagement portion engaged with the hole portion;
a second engagement portion engaged with an inclined side root of the projection portion; and
a flexible portion having flexibility and connecting the first engagement portion and the second engagement portion.

5. The maintenance device according to claim 1, comprising:
a waste liquid tray, wherein
the waste liquid tray includes:
a slit which guides the support along the moving direction, and
a plurality of recesses which are arranged in a staggered pattern on both sides of the slit in a direction intersecting the moving direction, each of which houses the blade unit, wherein
the support includes a plurality of the projection portions having the same number as the plurality of the recesses.

6. An inkjet recording apparatus comprising:
the maintenance device according to claim 1, and
the inkjet head.
